(19) United States
(12) Patent Application Publication
(10) Pub. No.: US 2014/0042755 A1
(43) Pub. Date: Feb. 13, 2014

(54) CASE LATCH ASSEMBLY

(71) Applicant: Penn Elcom Ltd., East Sussex (GB)

(72) Inventor: Dennis GOODMAN, East Sussex (GB)

(21) Appl. No.: 13/935,045

(22) Filed: Jul. 3, 2013

(30) Foreign Application Priority Data
Jul. 3, 2012 (EP) 12174757.0

(51) Int. Cl. E05C 19/10

(52) U.S. Cl. CPC E05C 19/105
USPC 292/65

(57) ABSTRACT

A case latch assembly having strike plate member on first lock mounting part; hinge member mounted for pivotable movement on second lock mounting part; strike plate engagement member mounted on the hinge member for reciprocal linear movement thereon and having coupling slot provided therein extending generally lengthways and having cam slot provided therein extending generally crossways; rotatably mounted lock nut; cam pin connected to the lock nut at an off-centre position and engaged with the cam slot; and coupling pin connected to the lock nut at a second position and located through the coupling slot. Rotation of the lock nut is translated by movement of the cam pin within the cam slot into linear movement of the strike plate engagement member between a closed position and an extended position and wherein the coupling pin moves along the coupling slot during the rotation of the lock nut.

The present invention relates to a case latch assembly.

Case latches for securing the lid and body of a case together are well known and typically comprise first and second parts of a split dish, each part being externally mounted respectively on the body and lid of a case. The first part is typically provided with a rotatably mounted hinge plate comprising a slider element moveably mounted on the hinge plate. The slider element comprises a latch hook and is arranged to move by means of an actuator. The actuator in prior art case latches typically comprises a figure eight shaped cam and cam slot, as described for example in U.S. Pat. No. 5,511,834. A catch plate is provided on the second part of the split dish, and the latch hook is adapted to hook onto the catch plate, and hold the case closed. To open the latch, the actuator is operated by a user to move the latch hook out of engagement with the catch plate, and the hinge plate may then be rotated by the user so that the latch hook is swung up and away from the catch plate to allow the case to be opened.

According to an aspect of the present invention there is provided a case latch assembly comprising:

a strike plate member provided on a first lock mounting part;

a hinge member mounted for pivotable movement on a second lock mounting part;

a strike plate engagement member mounted on the hinge member for reciprocal linear movement thereon and having a coupling slot provided therein which extends generally lengthways and having a cam slot provided therein which extends generally crossways;

a rotatably mounted lock nut;
a cam pin connected to the lock nut at an off-centre position and engaged with the cam slot; and
a coupling pin connected to the lock nut at a second position and located through the coupling slot,
wherein rotation of the lock nut is translated by movement of the cam pin within the cam slot into linear movement of the strike plate engagement member between a closed position and an extended position and wherein the coupling pin moves along the coupling slot during the rotation of the lock nut.

The provision of a cam slot and a coupling slot may enable the coupling pin to pass through the strike plate engagement member for connection with the lock nut without interfering with the motion of the strike plate engagement member when it is being moved between its closed and extended positions. This may allow the case latch assembly to have a slimmer construction than that of prior art case latches which use a figure of eight shaped cam and cam slot based latch actuation mechanism.

In an embodiment, the coupling slot has a curved shape. This may constrain the path of the coupling pin without interfering with the motion of the strike plate engagement member, which may ensure smooth movement of the strike plate engagement member between the closed and extended positions.

In an embodiment, the cam slot extends generally from a central region of the coupling slot. This may maximise the range of movement of the coupling pin.

In an embodiment, the coupling slot and the cam slot are provided together as a generally T-shaped slot or a generally mushroom-shaped slot. This may minimise the size of the strike plate engagement member and therefore the size of the case latch assembly.

In an embodiment, the cam slot has a retaining element provided towards its end closest to the coupling slot. The retaining element is arranged to retain the cam pin at said end. The strike plate engagement member may therefore be retained in its closed position and the latch may be prevented from opening accidentally, such as due to vibration or through being knocked.

In an embodiment, the retaining element is a nodule extending from a wall of the cam slot. In operation the cam pin rides up and over the nodule into a retained position at the said end of the cam slot.

In an embodiment, a generally circular retaining aperture is provided in the hinge member and the cam pin and the coupling pin are located through the retaining aperture. The retaining aperture may constrain the movement of the cam pin and the coupling pin, which may ensure smooth movement of the strike plate engagement member between the closed and extended positions.

In an embodiment, the cam pin and the coupling pin each comprise a coupling collar at one end configured to couple with one side of the strike plate engagement member and the locking nut is provided generally at the other side of the strike plate engagement member. In an embodiment, the cam pin and the coupling pin each comprise a rivet.

In an embodiment, the hinge member is mounted on at least one resilient member which is configured to bias the strike plate engagement member into the closed position. This may assist in retaining the cam pin in the retained position and may thereby assist in retaining the strike plate engagement member in the closed position. In an embodiment, the at least one resilient member comprises a spring configured to apply tension to the hinge member, to thereby bias the strike plate engagement member into the closed position.

In an embodiment, the first and second lock mounting parts comprise respective first and second mounting dishes, the first and second mounting dishes together comprising a latch dish. This may enable the first and second mounting dishes to be received by respective recesses in a case so that the case latch assembly is mounted substantially flush with a surface of the case.

Embodiments of the invention will now be described in detail, by way of example only, with reference to the accompanying drawings, in which:

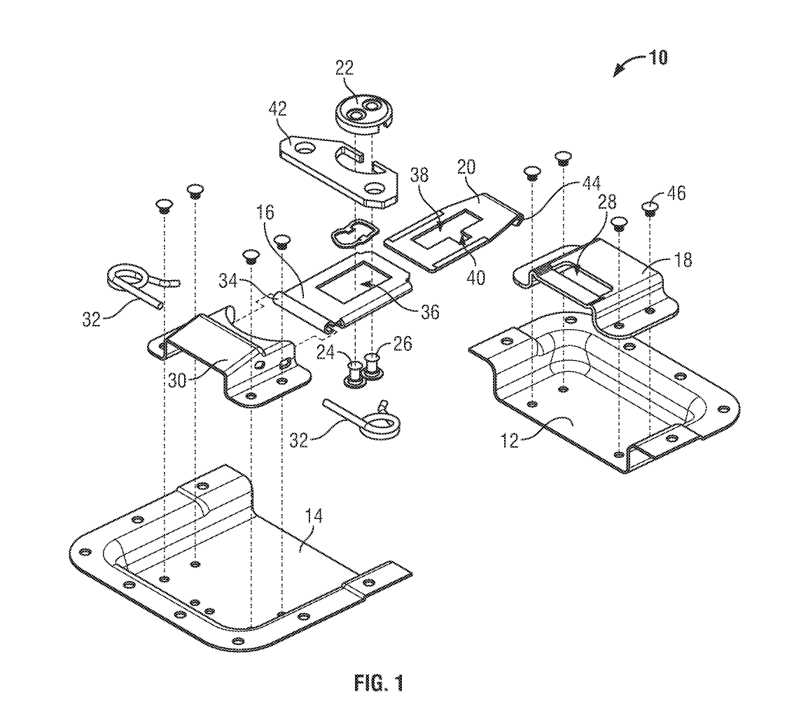

FIG. 1 is a diagrammatic exploded view of a case latch assembly according to a first embodiment of the invention;

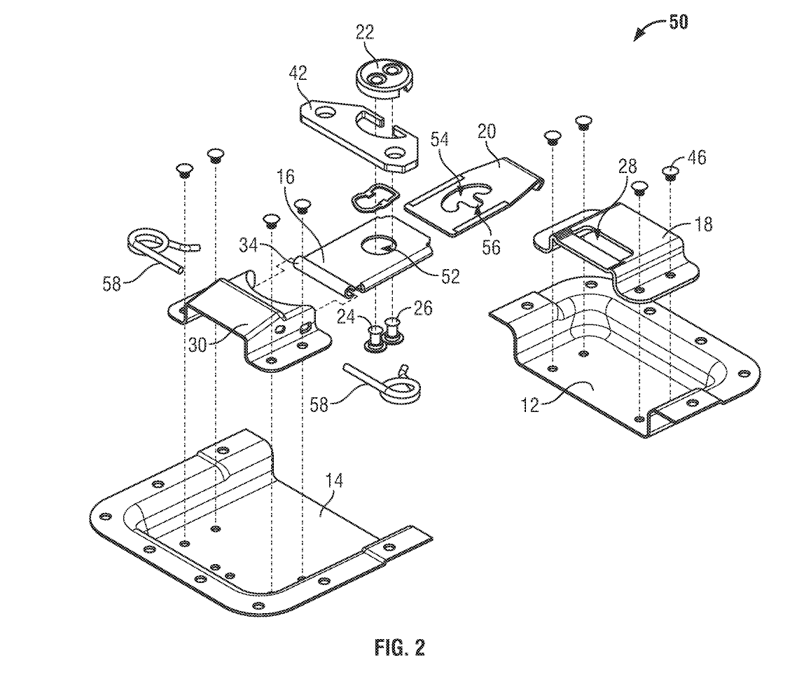

FIG. 2 is a diagrammatic exploded view of a case latch assembly according to a second embodiment of the invention;

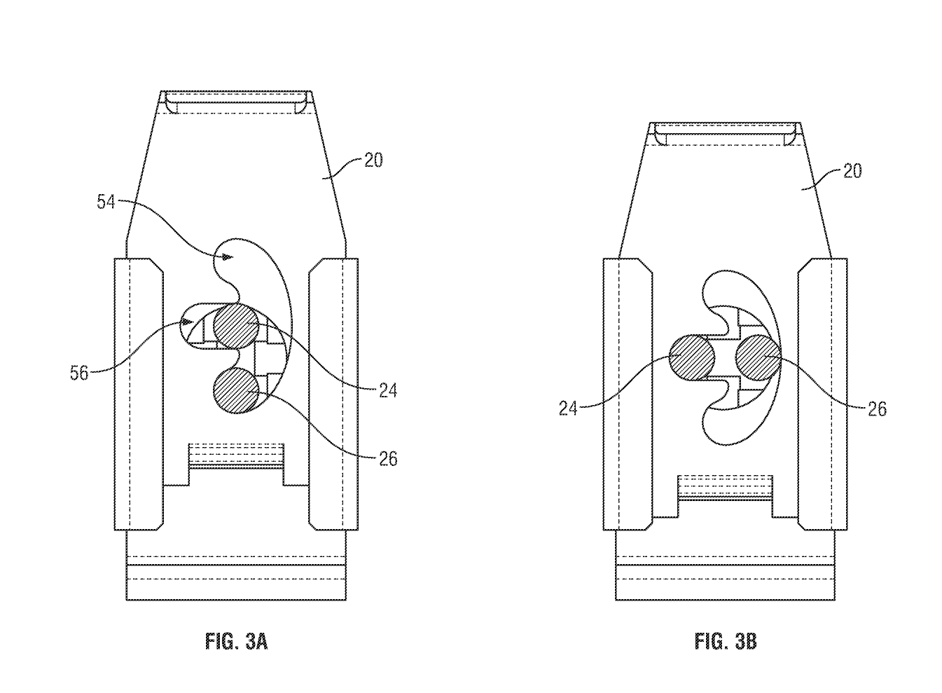

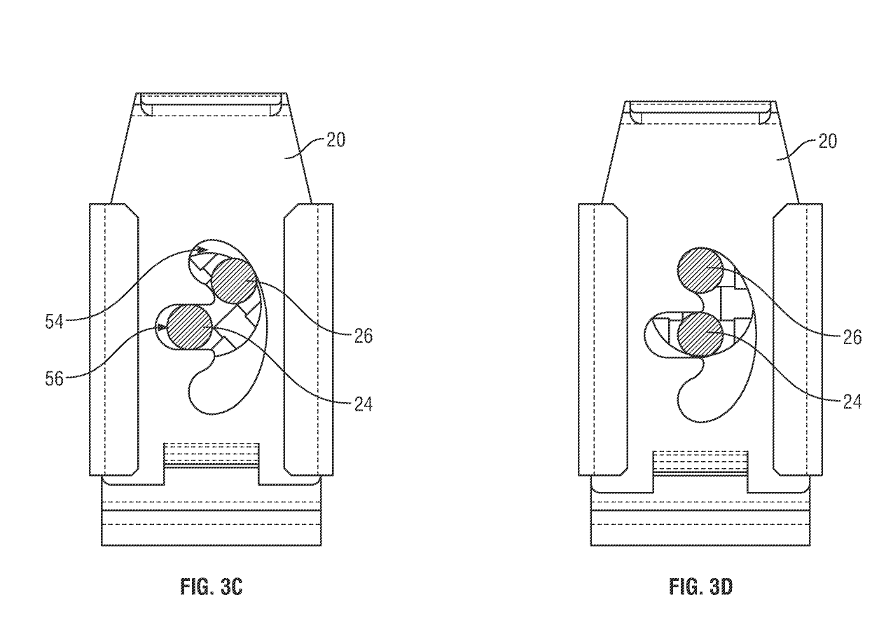

FIGS. 3a to 3d illustrate the strike plate engagement member of FIG. 2 moving from the extended position to the closed position;

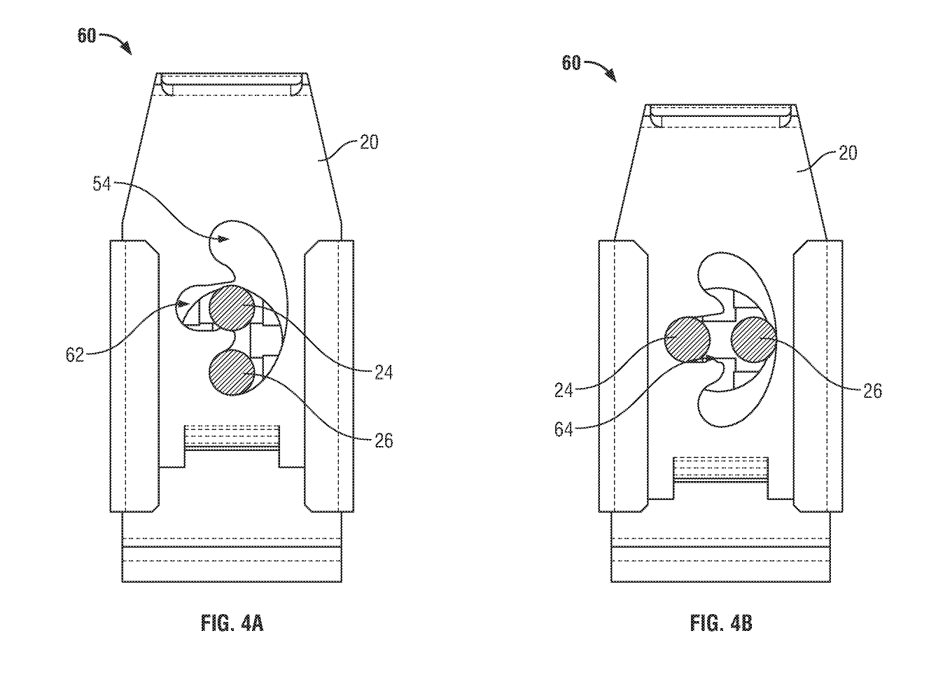

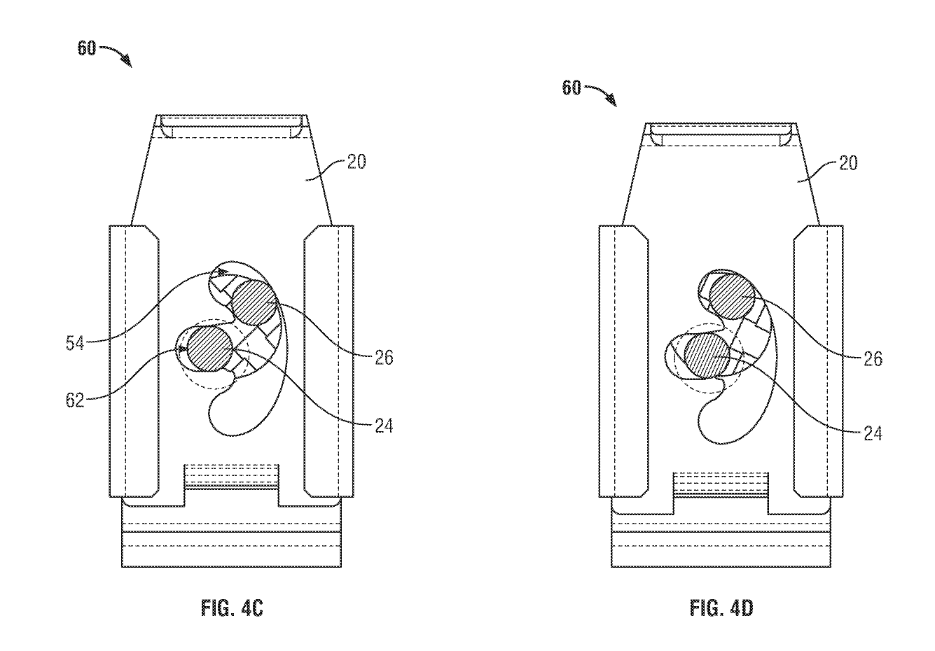

FIGS. 4a to 4e illustrate the strike plate engagement member of a case latch assembly according to a third embodiment of the invention moving from the extended position to the closed position; and

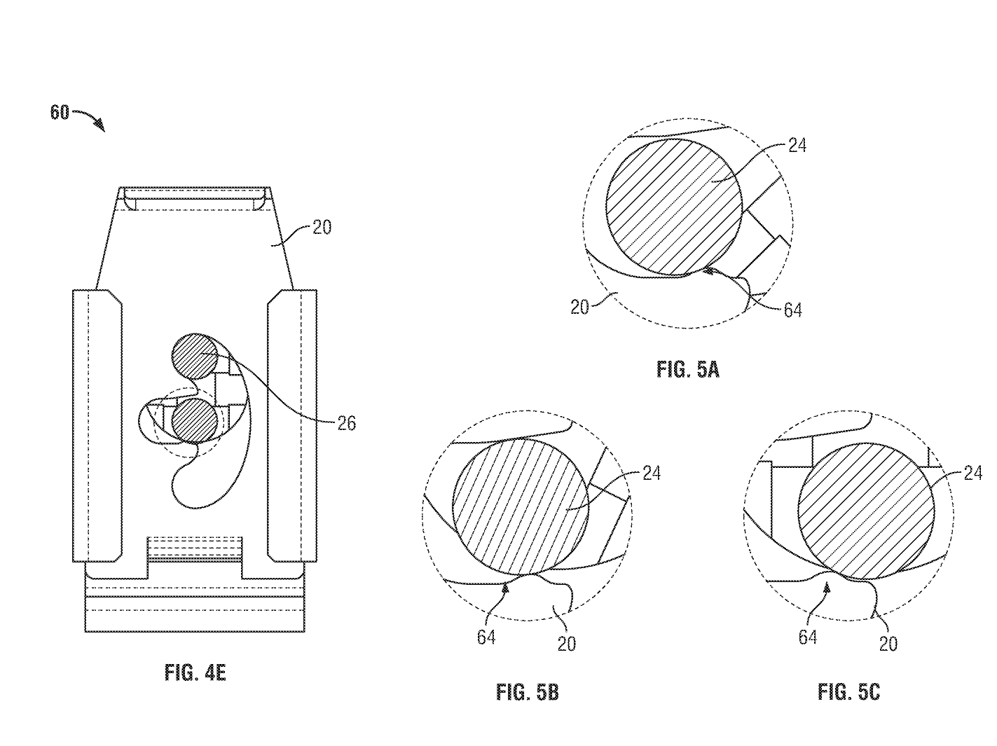

FIGS. 5a to 5c show the retaining element of the cam slot of the case latch assembly of FIGS. 4a to 4e and illustrate movement of the cam pin with respect to the retaining element.

Referring to FIG. 1 a first embodiment of the invention provides a case latch assembly 10 comprising a first lock mounting part 12, a second lock mounting part 14, a hinge member 16, a strike plate member 18, a strike plate engagement member 20, a lock nut 22, a cam pin 24 and a coupling pin 26.

In this example, the first 12 and second 14 lock mounting parts comprise respective first and second mounting dishes. The mounting dishes 12, 14 together form a latch dish and are arranged to be respectively located on the lid and body of a case. Each mounting dish 12, 14 is arranged to be located in a respective aperture (not shown) in the case (not shown) so that the mounting dishes 12, 14 may be mounted substantially flush with a surface of the case.

The strike plate member 18 is mounted on the first mounting dish 12 and defines a strike plate aperture 28.

The case latch 10 further comprises a mounting element 30 and mounting pins 32. The mounting element 30 is provided on the second mounting dish 14 and is configured to receive the mounting pins 32. The hinge member 16 is provided with a mounting hook 34 at one end and an aperture 36. The mounting hook 34 is located around the mounting pins 32 such that the hinge member 16 is mounted for pivotable movement.

The strike plate engagement member 20 is mounted for reciprocal linear movement on the hinge member 16. The strike plate engagement member 20 has a coupling slot 38 and a cam slot 40 provided in it. The coupling slot 38 extends generally lengthways and the cam slot 40 extends generally crossways. The strike plate engagement member 20 is provided with a strike plate hook 44 at the opposite end to the mounting hook 34. The hook 44 is configured to engage the strike plate member 18, through its aperture 28, when the strike plate engagement member 20 is in a closed, locked position.

The lock nut 22 is rotatably mounted and is provided with an actuation key 42 for manual rotation of the lock nut 22 by a user. The cam pin 24 is connected to the lock nut 22 at an off-centre position and is located through and engaged with the cam slot 40. The coupling pin 26 is connected to the lock nut 22 at a second position and is located through the coupling slot 38. Both pins 24, 26 extend through the aperture 36 in the hinge member 36.

The case latch assembly 10 is further provided with a number of fixing rivets 46.

In use, the case latch assembly 10 is operated by a user manually rotating the lock nut 22 with the actuation key 42. The rotation of the lock nut is translated by movement of the cam pin 24 within the cam slot 40 into linear movement of the strike plate engagement member 20 between a closed position and an extended position. During rotation of the lock nut 22 and the strike plate engagement member 20 the coupling pin 26 moves along the coupling slot 38.

A second embodiment of the invention provides a case latch assembly 50 as shown in FIGS. 2 and 3. The case latch assembly 50 of this embodiment is similar to the latch assembly 10 of the first embodiment, with the following modifications. The same reference numbers are retained for corresponding features.

In this embodiment, a circular retaining aperture 52 is provided in the hinge member 16. The cam pin 24 and the coupling pin 26 are located through the retaining aperture which constrains their movement.

The coupling slot 54 of this embodiment has a curved shaped, to more closely match the curved path of the coupling pin 26 during actuation of the case latch 50. The curved shape may constrain the path of the coupling pin without interfering with the motion of the strike plate engagement member 20, which may ensure smooth movement of the strike plate engagement member between the closed and extended positions.

The cam slot 56 extends generally from the central region of the coupling slot 54. The coupling slot 54 and the cam slot 56 are provided together as a single generally mushroom-shaped slot.

The hinge member 16 is mounted for pivotable movement on a pair of spring 58. The springs are configured to apply tension to the hinge member to thereby bias the strike plate engagement member 20 into the closed position.

FIG. 3 illustrates movement of the strike plate engagement member 20 from the extended position (FIG. 3a) through intermediate positions (FIGS. 3b and 3c) to the closed position (FIG. 3d). In the extended position the coupling pin 26 is located at one end of the coupling slot 54 and the cam pin 24 is located at the end of the cam slot 56 adjacent the coupling slot 54. As the lock nut 22 is rotated the cam pin 24 is moved to the distal end of the cam slot and the position of the coupling pin 26 moves along the coupling slot to the mid-point (FIG. 3b). Further rotation of the lock nut causes the cam pin to move away from the distal end of the cam slot, back towards the coupling slot and the position of the coupling pin 26 moves further along the coupling slot towards the other end (FIG. 3c). In the closed position the cam pin 24 is back at its starting position within the cam slot 56, adjacent the coupling slot 54, and the coupling pin is located at the opposite end of the coupling slot to where it started.

A fourth embodiment of the invention provides a case latch assembly 60 part of which is shown in FIGS. 4 and 5. The case latch assembly 60 of this embodiment is similar to the case latch assembly 50 shown in FIGS. 2 and 3, with the following modifications. The same reference numbers are retained for corresponding features.

In this embodiment, the cam slot 62 has a retaining element 64 provided towards its end closest to the coupling slot 54. The retaining element is a nodule 64 extending from a wall of the cam slot 62. The retaining element is arranged to retain the cam pin at the end of the cam slot and therefore retains the strike plate engagement member in its closed position. The retaining element 64 may prevent the case latch 60 from opening accidentally, such as due to vibration or through being knocked.

As shown best in FIG. 5, in operation the cam pin 24 rides up and over the nodule 64 into and out of a retained position at the end of the cam slot 62. As the strike plate engagement member 20 moves from the extended position (FIG. 4a) into the closed position (FIGS. 4e and 5c) the cam pin 24 rides up one side of the nodule 64 (FIG. 5a), over the nodule (FIG. 5b) and down the other side of the nodule (FIG. 5c) into the retained position. Movement out of the retained position is the reverse, i.e. FIGS. 5c to 5a.

1. A case latch assembly (10, 50, 60) comprising:
a strike plate member (18) provided on a first lock mounting part (12);
a hinge member (16) mounted for pivotable movement on a second lock mounting part (14);
a strike plate engagement member (20) mounted on the hinge member for reciprocal linear movement thereon and having a coupling slot (38, 54) provided therein which extends generally lengthways and having a cam slot (40, 56, 62) provided therein which extends generally crossways;
a rotatably mounted lock nut (22);
a cam pin (24) connected to the lock nut at an off-centre position and engaged with the cam slot; and
a coupling pin (26) connected to the lock nut at a second position and located through the coupling slot,
wherein rotation of the lock nut is translated by movement of the cam pin within the cam slot into linear movement of the strike plate engagement member between a closed position and an extended position and wherein the coupling pin moves along the coupling slot during the rotation of the lock nut.

2. A case latch assembly as claimed in claim 1, wherein the coupling slot (54) has a curved shape.

3. A case latch assembly as claimed in claim 1, wherein the cam slot (40, 56, 62) extends generally from a central region of the coupling slot.

4. A case latch assembly as claimed in claim 1, wherein the coupling slot (54) and the cam slot (56, 62) are provided together as a generally T-shaped slot or a generally mushroom-shaped slot.

5. A case latch assembly as claimed in claim 1, wherein the cam slot (62) has a retaining element (64) provided towards its end closest to the coupling slot.

6. A case latch assembly as claimed in claim 5, wherein the retaining element (64) is a nodule extending from a wall of the cam slot (62).

7. A case latch assembly as claimed in claim 1, wherein a generally circular retaining aperture (52) is provided in the hinge member and the cam pin (24) and the coupling pin (26) are located through the retaining aperture.

8. A case latch assembly as claimed in claim 1, wherein the cam pin (24) and the coupling pin (26) each comprise a coupling collar at one end configured to couple with one side of the strike plate engagement member and the locking nut (22) is provided generally at the other side of the strike plate engagement member (20).

9. A case latch assembly as claimed in claim 5, wherein the cam pin (24) and the coupling pin (26) each comprise a rivet.

10. A case latch assembly as claimed in claim 1, wherein the hinge member (16) is mounted on at least one resilient member (58) which is configured to bias the strike plate engagement member (20) into the closed position.

11. A case latch assembly as claimed in claim 10, wherein the at least one resilient member (58) comprises a spring configured to apply tension to the hinge member (16), to thereby bias the strike plate engagement member (20) into the closed position.

12. A case latch assembly as claimed in claim 1, wherein the first and second lock mounting parts comprise respective first and second mounting dishes (12, 14), the first and second mounting dishes together comprising a latch dish.
